(19) United States
(12) Patent Application Publication
(10) Pub. No.: US 2018/0051672 A1
(43) Pub. Date: Feb. 22, 2018

(54) JOINTED ROTOR BLADE FOR WIND TURBINE

(71) Applicant: General Electric Company, Schenectady, NY (US)

(72) Inventors: Thomas Merzhaeuser, Munich (DE); Sara Simonne Louisa Delport, Munich (DE); Andrew Mitchell Rodwell, Greenville, SC (US); Aaron Alpheus Yarbrough, Greenville, SC (US)

(21) Appl. No.: 15/241,281

(22) Filed: Aug. 19, 2016

(51) Int. Cl. F03D 1/06; F03D 1/00

(52) U.S. Cl. CPC F03D 1/0675; F03D 1/001

(57) ABSTRACT

A spar cap assembly for a jointed rotor blade of a wind turbine includes a root spar cap assembly and a tip spar cap assembly. The root spar cap assembly includes a root tensile spar cap and a root compressive spar cap, and is formed from a first composite material. The tip spar cap assembly includes a tip tensile spar cap and a tip compressive spar cap, and is formed from a second composite material that is different from the first composite material. The thickness of a joining end of the root tensile spar cap is different from the thickness of a joining end of the tip tensile spar cap, and the thickness of a joining end of the root compressive spar cap is different from the thickness of a joining end of the tip compressive spar cap.

### BACKGROUND

The present application relates generally to a jointed rotor blade of a wind turbine, and more particularly, to a spar cap assembly for a jointed rotor blade of a wind turbine.

Wind power is considered as one of the cleanest and environmentally friendly energy sources presently available, and wind turbines have gained increased attention in this regard. A modern wind turbine typically includes a tower, generator, gearbox, nacelle, and one or more rotor blades. The rotor blades capture kinetic energy from the wind and transmit the kinetic energy through rotational energy to turn a shaft that couples the rotor blades to a gearbox, or if a gearbox is not used, directly to the generator. The generator then converts the rotational energy to electrical energy that may be deployed to a utility grid.

Rotor blades of the wind turbine generally include a shell body formed by two shell halves, generally made of a composite material. The individual shell halves are generally manufactured using molding processes and are then coupled together along the corresponding edges of the rotor blade. In general, the shell body is relatively light in weight and the structural properties (e.g., stiffness, buckling resistance and strength) of the shell body may not be able to withstand the bending moments and other loads exerted on the rotor bade during operation. To increase the stiffness, buckling resistance and strength of the rotor blade, the shell body is typically reinforced using spar caps that engage the inner surfaces of the shell halves. As such, flap-wise or span-wise bending moments and loads, which cause a rotor blade tip to defect towards the wind turbine tower, are generally transferred along the rotor blade through the spar caps.

In recent years, sizes of the wind turbines for wind power generation have increased to improve power generation efficiency and the absolute power generated. Along with the increase in size of wind turbines for wind power generation, wind turbine rotor blades have also increased in length. For example, an average blade length of a newer generation wind turbine may be 40 meters or more. When the wind turbine rotor blade is increased in length as described above, various challenges occur. For example, difficulties may arise in integral manufacture and in securing roads and trucks for conveyance. Therefore, it is desirable to construct wind blades as segments to enable manufacture of a rotor blade in a modular manner For example, longitudinal segments of a wind blade may be manufactured separately for ease of handling and transportation and then assembled into full length rotor blades at a wind farm site.

Different designs and methods have been investigated in the past to join two blade segments and to rebuild the blade to full length at site. Joining two blade segments may incur additional cost, weight, field assembly time and reliability. For example, a joint generally adds weight to the rotor blade. The additional weight due to the joint in a rotor blade increases the weight of the blade, and impacts static moment, inertia and Eigen frequencies of the rotor blade, resulting in a system load increase.

Generally, spars and spar caps contribute to a major part of the rotor blade mass. Accordingly, there is a need for a spar cap design that allows for a reduction in blade mass and/or material costs without sacrificing the performance of the rotor blade.

### BRIEF DESCRIPTION

In one aspect, a spar cap assembly for a jointed rotor blade of a wind turbine is disclosed. The spar cap assembly includes a root spar cap assembly and a tip spar cap assembly. The root spar cap assembly includes a root tensile spar cap and a root compressive spar cap, and is formed from a first composite material. The tip spar cap assembly includes a tip tensile spar cap and a tip compressive spar cap, and is formed from a second composite material. The second composite material is different from the first composite material. The thickness of a joining end of the root tensile spar cap is different from the thickness of a joining end of the tip tensile spar cap, and the thickness of a joining end of the root compressive spar cap is different from the thickness of a joining end of the tip compressive spar cap.

In another aspect, a jointed rotor blade of a wind turbine is disclosed. The jointed rotor blade includes a root blade segment joined to a tip blade segment at a joint and a spar cap assembly at the joint. The spar cap assembly includes a root spar cap assembly and a tip spar cap assembly. The root spar cap assembly includes a root tensile spar cap and a root compressive spar cap, and is formed from a first composite material. The tip spar cap assembly includes a tip tensile spar cap and a tip compressive spar cap, and is formed from a second composite material that is different from the first composite material. The tip tensile spar cap is adjacent to the root tensile spar cap at the joint, and the tip compressive spar cap is adjacent to the root compressive spar cap at the joint. The thickness of a joining end of the root tensile spar cap is different from the thickness of a joining end of the tip tensile spar cap. Further, the thickness of a joining end of the root compressive spar cap is different from the thickness of a joining end of the tip compressive spar cap.

In yet another aspect, a wind turbine is disclosed. The wind turbine includes a jointed rotor blade. The jointed rotor blade includes a root blade segment joined to a tip blade segment at a joint and a spar cap assembly at the joint. The spar cap assembly includes a root spar cap assembly and a tip spar cap assembly. The root spar cap assembly includes a root tensile spar cap and a root compressive spar cap, and is formed from a first composite material. The tip spar cap assembly includes a tip tensile spar cap and a tip compressive spar cap, and is formed from a second composite material that is different from the first composite material. The tip tensile spar cap is adjacent to the root tensile spar cap at the joint, and the tip compressive spar cap is adjacent to the root compressive spar cap at the joint. The thickness of a joining end of the root tensile spar cap is different from the thickness of a joining end of the tip tensile spar cap. Further, the thickness of a joining end of the root compressive spar cap is different from the thickness of a joining end of the tip compressive spar cap.

### DRAWINGS

These and other features, aspects, and advantages of the present disclosure will become better understood when the following detailed description is read with reference to the accompanying drawings in which like characters represent like parts throughout the drawings.

FIG. 1 is an illustration of an exemplary wind turbine.

FIG. 2 is an exemplary illustration of a jointed rotor blade having a root blade segment and a tip blade segment, in accordance with some embodiments of the present disclosure.

FIG. 3A is a perspective view of a joining end of the root blade segment of the jointed rotor blade, in accordance with some embodiments of the present disclosure.

FIG. 3B is a perspective view of a joining end of the tip blade segment of the jointed rotor blade, in accordance with some embodiments of the present disclosure.

FIG. 4 is a perspective view of a section of the tip blade segment of the jointed rotor blade, in accordance with an example of the present disclosure.

FIG. 5 is a perspective view of a section of the root blade segment of the jointed rotor blade, in accordance with an example of the present disclosure.

FIG. 6 is a perspective view of the assembly of the jointed rotor blade, in accordance with an example of the present disclosure.

### DETAILED DESCRIPTION

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

To more clearly and concisely describe and point out the subject matter, the following definitions are provided for specific terms, which are used throughout the following description and the appended claims, unless specifically denoted otherwise with respect to particular embodiments. The terms “wind blade” and “rotor blade” are used interchangeably in the present disclosure. As used herein, a “jointed rotor blade” is a rotor blade that includes at least one joint. A “spar cap assembly” is a combination of different spar caps present in the rotor blade. A spar cap that is present in a side of the rotor blade that experiences tensile force during rotation is termed as a tensile spar cap, and a spar cap that is in the side of the rotor blade that experiences compression during rotation is termed as a compressive spar cap. A “root spar cap assembly” is a combination of spar caps present in the root blade segment, and a “tip spar cap assembly” is a combination of spar caps present in the tip blade segment of the jointed rotor blade. A “joining end” is an end that is exposed to the joint. In a chord-wise joint, a joining end of the root blade segment faces the joining end of the tip blade segment at the joint at a specific span length of the jointed blade. A “thickness of a joining end of the root tensile spar cap” is defined as the thickness between the inner face of the root tensile spar cap and the inner surface of the body shell at the joining end of the root blade segment. A “thickness of a joining end of the root compressive spar cap” is defined as the thickness between the inner face of the root compressive spar cap and the inner surface of the body shell at the joining end of the root blade segment. A “thickness of a joining end of the tip tensile spar cap” is defined as the thickness between the inner face of the tip tensile spar cap and the inner surface of the body shell at the joining end of the tip blade segment. A “thickness of a joining end of the tip compressive spar cap” is defined as the thickness between the inner face of the tip compressive spar cap and the inner surface of the body shell at the joining end of the tip blade segment.

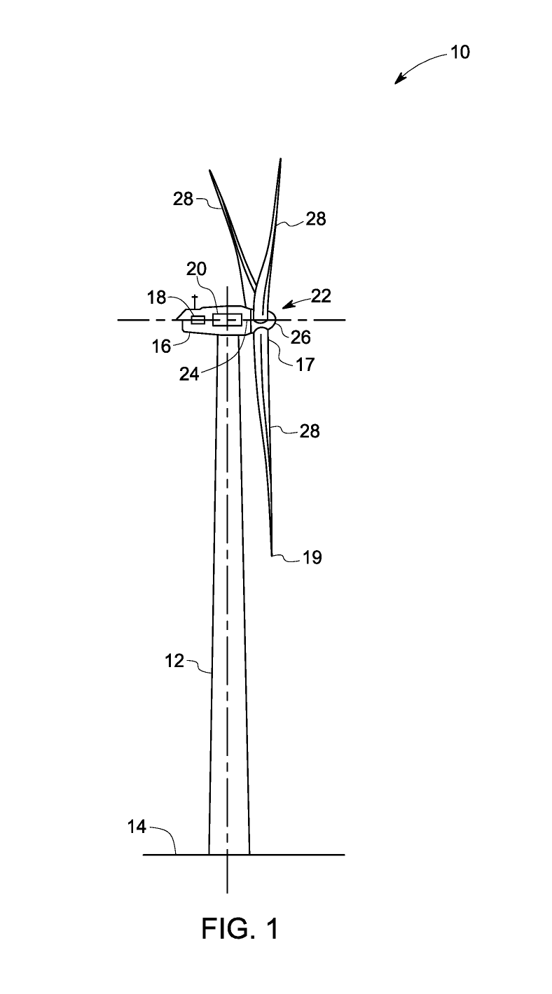

FIG. 1 is a side view of an exemplary wind turbine 10. In FIG. 1, the wind turbine 10 is a horizontal-axis wind turbine. Alternatively, the wind turbine 10 may be a vertical-axis wind turbine. In some embodiments, the wind turbine 10 includes a tower 12 that extends from a support surface 14, a nacelle 16 mounted on the tower 12, a generator 18 positioned within the nacelle 16, a gearbox 20 coupled to the generator 18, and a rotor 22 that is rotationally coupled to the gearbox 20 with a rotor shaft 24. The rotor 22 includes a rotatable hub 26 and at least one rotor blade 28 coupled to and extending outward from the rotatable hub 26. As shown, the rotor blade 28 includes a blade root end 17 and a blade tip end 19. The rotor 22 herein includes three rotor blades 28. However, in an alternative embodiment, the rotor 22 may include more or less than three rotor blades 28. Additionally, the tower 12 may be any suitable type of tower having any suitable height. The rotor blades 28 may be spaced about the hub 26 to facilitate rotating the rotor 22 to enable kinetic energy to be transferred from the wind into usable mechanical energy, and subsequently, electrical energy. Specifically, the hub 26 may be rotatably coupled to the electric generator 18 to permit electrical energy to be produced.

In general, the present disclosure is directed to a jointed rotor blade 29 having a spar cap assembly that includes a root spar cap assembly and a tip spar cap assembly. In particular, the present disclosure discloses spar caps of the root blade segment and the tip blade segment formed from different composite materials, which have differing thicknesses depending on the mechanical properties of the respective composite materials. For example, when the specific strength and/or modulus of elasticity of a first composite material is lower than the specific strength and/or modulus of elasticity respectively of a second composite material, the thickness of the spar cap having the first composite material may be increased and the thickness of the spar cap having the second composite material may be decreased, as compared to a pair of symmetrical spar caps having same composite material, without sacrificing the bending strength, stiffness or buckling resistance of the rotor blade. In some embodiments, the observed decrease in weight, and decreased cost of the rotor blade is efficiently used to over compensate the observed increase in cost of the rotor blade by introducing a second composite material. In certain embodiments, an overall reduction in material costs and blade mass is be achieved by altering the composite material and, thereby, the thickness of the tip spar cap assembly with respect to the root spar cap assembly.

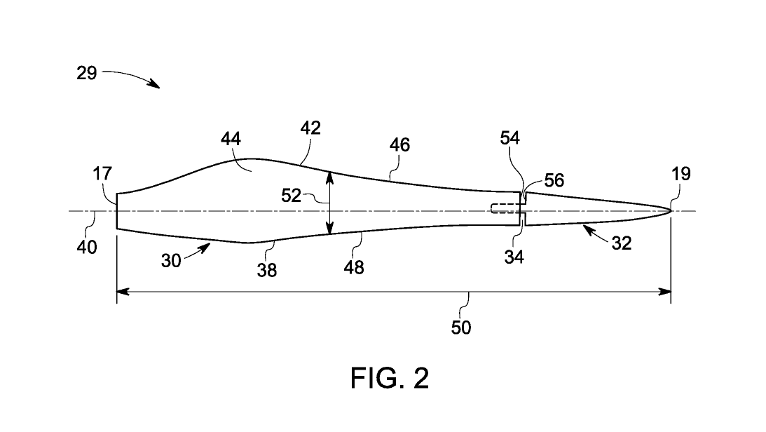

FIG. 2 further illustrates a perspective view of the jointed rotor blade 29 having a root blade segment 30 and a tip blade segment 32, in accordance with an example of the present disclosure. The root blade segment 30 and the tip blade segment 32 extend in opposite directions from a joint 34. In the jointed rotor blade 29, the root blade segment 30 and the tip blade segment 32 are connected by at least one supporting inner structure, such as, for example, a spar, extending into both blade segments 30, 32 to facilitate joining of the blade segments 30, 32.

A body shell 38 of the jointed rotor blade 29 generally extends to the root blade segment 30 and the tip blade segment 32 along a longitudinal axis 40. The body shell 38 may generally serve as the outer casing/covering of the jointed rotor blade 29 and may define a substantially aerodynamic profile, such as by defining a symmetrical or cambered air foil-shaped cross-section. The body shell 38 may also define a pressure side 42 and a suction side 44 extending between leading edge 46 and trailing edge 48 of the jointed rotor blade 29. Further, the jointed rotor blade 29 may also have a span 50 defining the total length between the blade root end 17 and the blade tip end 19 and a chord 52 defining the total length at a particular point along the span between the leading edge 46 and the trailing edge 48. As is generally understood, the chord 52 may generally vary in length with respect to the span 50 as the jointed rotor blade 29 extends from the blade root end 17 and the blade tip end 19. The joint 34 joins the root blade segment 30 to the tip blade segment 32 at the joining end 54 of the root blade segment and the joining end 56 of the tip blade segment. The joint 34 may be at any distance from the root end 17 along the span 50 of the jointed rotor blade 29. In some embodiments, the joint 34 is at a span in a range from about 50% to about 90% from the root end 17 of the jointed rotor blade 29. In some specific embodiments, the joint 34 is at a span in a range from about 65% to about 80% from the root end 17 of the jointed rotor blade 29. While the joint 34 in FIG. 2 is illustrated herein as a chord-wise joint, other kinds of joints may be envisaged for joining the tip blade segment 32 to the root blade segment 30.

In several embodiments, the body shell 38 of the jointed rotor blade 29 may be formed from a plurality of shell components. For example, the body shell 38 may be manufactured from a first shell half (not shown) generally defining the pressure side 42 of the jointed rotor blade 29 and a second shell half (not shown) generally defining the suction side 44 of the jointed rotor blade 29, with such shell halves being secured to one another at the leading and trailing edges 46, 48 of the jointed rotor blade 29. In some embodiments, the body shell 38 is separately molded to the tip blade segment 32 and the root blade segment 30, and joined at the time of joining the tip and root blade segments. In some other embodiments, the body shell 38 is molded to the jointed rotor blade 29 after joining inner structures of the tip blade segment 32 and the root blade segment 30. The body shell 38 may generally be formed from any suitable material. For instance, in some embodiments, the body shell 38 may be formed entirely from a laminate composite material, such as a carbon fiber reinforced composite or a glass fiber reinforced composite. Alternatively, one or more portions of the body shell 38 may be configured as a layered construction and may include a core material, formed from a lightweight material such as wood (e.g., balsa), foam (e.g., extruded polystyrene foam) or a combination of such materials, disposed between layers of composite material.

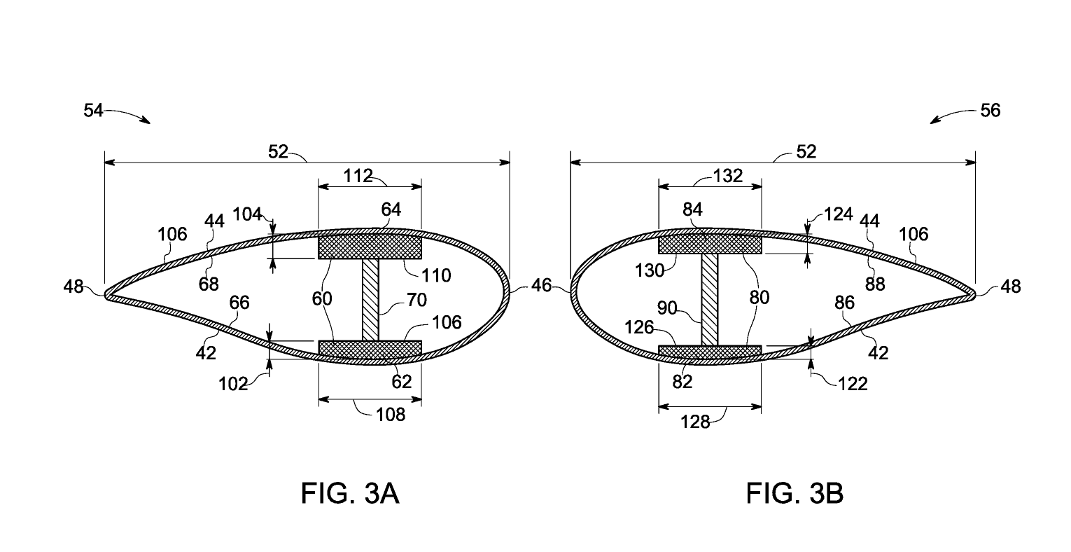

The jointed rotor blade 29 (illustrated in FIG. 2) may also include one or more longitudinally extending structural components configured to provide increased stiffness, buckling resistance and/or strength to the jointed rotor blade 29. These structural components may also be joined by joining the joining end 54 of the root blade segment 30 to the joining end 56 of the tip blade segment 32 at the joint 34. FIG. 3A illustrates a perspective view, along the axis 40, of an embodiment of the joining end 54 of the root blade segment 30 and FIG. 3B illustrates a perspective view, along the axis 40, of an embodiment of the joining end 56 of the tip blade segment 32, of the jointed rotor blade 29 at the joint 34 illustrated in FIG. 2. Referring to FIG. 3A, the joining end 54 of the root blade segment 30 of the jointed rotor blade 29 may include a root spar cap assembly 60 including a pair of longitudinally extending spar caps 62, 64 configured to be engaged (positioned) against the opposing inner surfaces 66, 68 of the pressure and suction sides 42, 44 respectively of the body shell 38 (illustrated in FIG. 2). Additionally, one or more root spars 70 may be disposed between the spar caps 62, 64 for load-bearing. Referring to FIG. 3B, the joining end 56 of the tip blade segment 32 of the jointed rotor blade 29 may include a tip spar cap assembly 80 including a pair of longitudinally extending spar caps 82, 84 configured to be engaged against the opposing inner surfaces 86, 88 of the pressure and suction sides 42, 44 respectively of the body shell 38 (illustrated in FIG. 2). Additionally, one or more tip spars 90 may be disposed between the spar caps 82, 84 so as to bear the load.

The spar caps 62, 64 of the root blade segment 30 and spar caps 82, 84 of the tip blade segment 32 may generally be designed to control the bending stresses and/or other loads acting on the rotor blade in a generally span-wise direction (a direction parallel to the span 50 of the jointed rotor blade 29 illustrated in FIG. 2) during operation of a wind turbine. For instance, bending stresses may occur on a jointed rotor blade 29 when the wind loads directly on the pressure side 42 of the jointed rotor blade 29, thereby subjecting the pressure side 42 to span-wise tension and the suction side 44 to span-wise compression as the rotor blade 29 bends in the direction of the wind turbine tower.

Thus, the spar cap 62 disposed on the pressure side 42 of the root blade segment is termed as the root tensile spar cap 62 and spar cap 82 disposed on the pressure side 42 of the tip blade segment is termed as the tip tensile spar cap 82. The root tensile spar cap 62 and the tip tensile spar cap 82 may generally be configured to withstand the span-wise tension occurring as the jointed rotor blade 29 is subjected to various bending moments and other loads during operation. Similarly, the spar cap 64 disposed on the suction side 44 of the root blade segment is termed as the root compressive spar cap 64 and spar cap 84 disposed on the suction side 44 of the tip blade segment is termed as the tip compressive spar cap 84. The root compressive spar cap 64 and the tip compressive spar cap 84 disposed on the suction side 44 of the jointed rotor blade may generally be configured to withstand the span-wise compression occurring during operation of the wind turbine 10.

The spar caps may be designed to have any advantageous shapes and cross-sectional areas. In an exemplary embodiment of the root tensile spar cap 62, the tip tensile spar cap 82, root compressive spar cap 64 and the tip compressive spar cap 84 having approximately rectangular cross-section, the spar caps 62, 64, 82, 84 may include a cross-sectional area equal to a product of a spar cap thickness and a chord-wise width of each individual spar cap 62, 64, 82, 84, as measured along the chord 52 defined between the leading edge 46 and the trailing edge 48. The spar cap thicknesses and/or the chord-wise width of the root tensile spar cap 62, the root compressive spar cap 64, the tip tensile spar cap 82, and the tip compressive spar cap 84 may vary along the span 50 of the jointed rotor blade 29. For example, the spar cap thickness may be less at the blade root end 17 end, may increase as the span of the rotor blade increases, may have a maximum (not shown) at a particular span and may be less again at the blade tip end 19 end of the jointed rotor blade 29. Depending on the location of the joint 34 at the span 50, the maximum of the spar cap thickness may be in the root blade segment 30 or at the tip blade segment 32. The increment and the decrease in the spar cap thicknesses are gradual in some embodiments, and is in a stepwise manner in some other embodiments.

For example, as shown in FIG. 3A, the root tensile spar cap 62 may generally have a root tensile spar cap thickness 102 (thickness between the inner face 106 of the root tensile spar cap 62 and the inner surface 66 of the body shell 38) at the joining end 54, and a chord-wise, root tensile spar cap width 108 at the joining end 54. Additionally, the root compressive spar cap 64 may generally have a root compressive spar cap thickness 104 (thickness between the inner face 110 of the compressive spar cap 84 and the inner surface 68 of the body shell 38) at the joining end 54, and a chord-wise, root compressive spar cap width 112 at the joining end 54. FIG. 3B illustrates the tip tensile spar cap 82 having a tip tensile spar cap thickness 122 (thickness between the inner face 126 of the tip tensile spar cap 82 and the inner surface 86 of the body shell 38) at the joining end 56, and a chord-wise, tip tensile spar cap width 128 at the joining end 56. Additionally, the tip compressive spar cap 84 is having a tip compressive spar cap thickness 124 (thickness between the inner face 130 of the tip compressive spar cap 84 and the inner surface 88 of the body shell 38) at the joining end 56, and a chord-wise, tip compressive spar cap width 132 at the joining end 56. A slight curvature at the inner faces 66, 68, 86, 88 of the body shell 38 and/or at the inner surfaces 106, 110, 126, 130 of the inner faces of the spar caps may cause a slight change in the thickness 102, 104, 122, 124 of the spar caps when measured along the widths 108, 112, 128, 132. However, these changes in the thickness are considered as incidental and for comparison between thicknesses of any two spar caps, maximum thickness of those two spar caps may be considered.

Depending on the properties of the material utilized to form the spar caps of the root blade segment 30 and the tip blade segment 32, the tensile and compressive spar caps of the root blade segment and the tip blade segment may generally be configured to define differing thicknesses and cross-sectional areas without any adverse effects on performance

The material and design of the spars and spar caps of the jointed rotor blades play a significant role in controlling the rotor blade mass. One design consideration for a rotor blade is the static moment of the blade. Lightweight and high stiffness materials, such as for example, carbon, are desired to be used in load-bearing structures such as the root and tip spars 70, 90, and the spar caps. However, most of the commonly known lightweight and high stiffness materials are expensive and limit cost effective application when the spar and spar caps of entire blade are constructed of a single material. The static moment benefit obtained by deploying lightweight and high stiffness materials towards the blade tip end 19 end of the blade is greater compared to the benefit obtained by deploying these materials at blade root end 17 end. Combining different materials of spars and spar caps as a function of span position can be effectively used for increasing the cost and performance benefits. A jointed rotor blade 29 provides a prospect to deploy different materials at the root blade segment 30 and the tip blade segment 32 of the jointed rotor blade 29.

In some aspects of the present disclosure, a spar cap assembly for a jointed rotor blade of a wind turbine is disclosed. The spar cap assembly includes a root spar cap assembly and a tip spar cap assembly. The root spar cap assembly 60 includes a root tensile spar cap and a root compressive spar cap, and is formed from the first composite material. The tip spar cap assembly 80 includes a tip tensile spar cap and a tip compressive spar cap, and is formed from the second composite material. The second composite material is different from the first composite material. The thickness of a joining end of the root tensile spar cap is different from the thickness of a joining end of the tip tensile spar cap, and the thickness of a joining end of the root compressive spar cap is different from the thickness of a joining end of the tip compressive spar cap.

In some aspects of the present disclosure, the root spar cap assembly 60 consists essentially of the first composite material, and the tip spar cap assembly 80 consists essentially of the second composite material. In some aspects, the material of the root spar 70 and the tip spar 90 are formed of same materials, irrespective of the materials used in the root spar cap assembly 60 and the tip spar cap assembly 80. However, in some other aspects, the material of the root spar 70 is similar to the material of the root spar cap assembly 60, and the material of the tip spar 90 is similar to the material of the tip spar cap assembly 80. In some embodiments, the material, design, thickness, width, or any combinations thereof of the root tensile spar cap 62 may vary from the respective aspects of the root compressive spar cap 64. Similarly, the material, design, thickness, width, or any combinations thereof of the tip tensile spar cap 82 may vary from the respective aspects of the tip compressive spar cap 84. In a specific aspect, the root tensile spar cap 62, the root compressive spar cap 64, and the root spar 70 are formed of the first composite material, and the tip tensile spar cap 82, the tip compressive spar cap 84, and the tip spar 90 are formed of the second composite material. The second composite material is different from the first composite material.

The specific strength and/or modulus of elasticity and the thickness of the spar caps may be effectively used to change thickness of the spar caps, without sacrificing the mechanical properties of the jointed rotor blade, when different composite materials are used in the root blade segment 30 and the tip blade segment 32. In some embodiments of the present disclosure, the root spar cap assembly 60 and the tip spar cap assembly 80 are formed from different composite materials. The thickness 102 of the joining end 54 of the root tensile spar cap 62 is different from the thickness 122 of the joining end 56 of the tip tensile spar cap 82, and the thickness 104 of the joining end 54 of the root compressive spar cap 64 is different from the thickness of the joining end 56 of the tip compressive spar cap 84.

In some embodiments, the tip spar cap assembly 80 is formed by the second composite material that has higher specific strength and/or modulus of elasticity from the first composite material forming the root spar cap assembly 60. In these embodiments, the thickness of the spar caps 82, 84 of the tip spar cap assembly 80 at the joining end 56 is decreased as compared to spar caps 62, 64 of the root spar cap assembly 60 at the joining end 54, without sacrificing the mechanical properties, such as, for example, bending strength, stiffness or buckling resistance of the jointed rotor blade 29. Thus, in some embodiments, the thickness 102 of the joining end 54 of the root tensile spar cap 62 is greater than the thickness 122 of the joining end 56 of the tip tensile spar cap 82, and the thickness 104 of the joining end 54 of the root compressive spar cap 64 is greater than the thickness 124 of the joining end 56 of the tip compressive spar cap 84.

In some embodiments, depending on the material characteristics of the first composite material and the second composite material, the specific strength and/or modulus of elasticity of the first composite material may be significantly different from the specific strength and/or modulus of elasticity respectively of the second composite material. This significant difference in the specific strength and/or modulus of elasticity permits a significant change in the thickness of the tensile and compressive spar caps. In some embodiments, specific strength of the second composite material is at least 30% greater than the specific strength of the first composite material. In some embodiments, elastic modulus of the second composite material is at least 30% greater than the elastic modulus of the first composite material.

In some embodiments, the thickness 102 of the joining end 54 of the root tensile spar cap 62 is at least 30% greater than the thickness 122 of the joining end 56 of the tip tensile spar cap 82. Similarly, in some embodiments, the thickness 104 of the joining end 54 of the root compressive spar cap 64 is at least 30% greater than the thickness 124 of the joining end 56 of the tip compressive spar cap 84. In certain embodiments, the thickness 102 of the joining end 54 of the root tensile spar cap 62 is at least 50% greater than the thickness 122 of the joining end 56 of the tip tensile spar cap 82. In some embodiments, the thickness 104 of the joining end 54 of the root compressive spar cap 64 is at least 50% greater than the thickness 124 of the joining end 56 of the tip compressive spar cap 84. In some specific embodiments, the thickness 102 of the joining end 54 of the root tensile spar cap 62 is at least 70% greater than the thickness 122 of the joining end 56 of the tip tensile spar cap 82. In some specific embodiments, the thickness 104 of the joining end 54 of the root compressive spar cap 64 is at least 70% greater than the thickness 124 of the joining end 56 of the tip compressive spar cap 84.

The cross sectional area (not shown) of the root tensile spar cap 62, root compressive spar cap 64, tip tensile spar cap 82, and tip compressive spar cap 84 may vary from each other. In some embodiments, wherein the thicknesses of the spar caps vary from each other as referred to above, the width of the spar caps may or may not differ across the joint 34. In some embodiments, the width 108 of the joining end 54 of the root tensile spar cap 62 is greater than the width 128 of the joining end 56 of the tip tensile spar cap 82, and width 112 of the joining end 54 of the root compressive spar cap 64 is greater than the width 132 of the joining end 56 of the tip compressive spar cap 84.

In some embodiments, the first composite material of the spar cap assembly of the jointed rotor blade 29 includes a matrix and a reinforcement. In some embodiments, the first composite material of the spar cap assembly of the jointed rotor blade 29 includes a reinforcement of fiberglass. The fiberglass may include E-glass, S-glass, R-glass or any combinations thereof. In some embodiments, the first composite material is reinforced with fiberglass. In some embodiments, the other materials that may be present as a part of the reinforcement are only incidental material impurities present in a concentration less than about 2 weight % of the reinforcement. In some embodiments, the second composite material of the spar cap assembly of the jointed rotor blade 29 includes a matrix and a reinforcement. In some embodiments, the reinforcement is selected from carbon, aramid, basalt, mixtures of carbon and aramid, mixtures of carbon and basalt, or mixtures of aramid and basalt. In some embodiments, the reinforcement is selected from mixtures of carbon and fiberglass, mixtures of aramid and fiberglass, mixtures of basalt and fiberglass, mixtures of carbon and fiberglass along with another reinforcement material, mixtures of aramid and fiberglass along with another reinforcement material, or mixtures of basalt and fiberglass along with another reinforcement material. In some embodiments, the reinforcement includes mixtures of carbon, aramid, basalt, and fiberglass. In some embodiments, the second composite material of the spar cap assembly of the jointed rotor blade 29 includes a reinforcement of carbon fiber, aramid fiber, or a combination of carbon and aramid fibers. In some embodiments, the second composite material is reinforced with carbon fiber, aramid fiber, or a combination thereof. Other materials may be present as a part of the reinforcement, or as incidental material impurities in a concentration less than about 2 weight % of the reinforcement. In certain embodiments, the first composite material is reinforced with fiberglass and the second composite material is reinforced with carbon fiber, aramid fiber, or a combination of carbon and aramid fibers. In one specific embodiment, the first composite material is reinforced with fiberglass and the second composite material is reinforced with carbon fiber. In another specific embodiment, the first composite material is reinforced with fiberglass and the second composite material is reinforced with aramid fiber. In some exemplary embodiments, the first composite material is reinforced with one type of fiberglass and the second composite material is reinforced with another type of fiberglass that has a different composition and higher strength as compared to the fiberglass reinforcement of the first composite material. The matrix materials of the first composite material and the second composite material may include thermosetting polymers or thermoplastics. Some examples of the thermoset polymers that may be used as a matrix for the first composite material and/or the second composite material include epoxies, polyesters, and vinylesters,

Changing the composite material of the tip blade segment 32 of the jointed rotor blade 29 from the commonly used glass fiber reinforced plastic (GFRP) to, for example, carbon fiber reinforced plastic (CFRP), can over compensate the increase in weight due to the joint 34, while maintaining the bending stiffness of the blade. Further, the capability of changing the composite material of the tip blade segment 32 enables formation of the jointed rotor blade 29 using any rotor blade as the baseline blade. Furthermore, using this technology, stronger and/or longer rotor blades may be formed for sites with wind conditions that are above the existing limit.

The use of multiple materials along the rotor blade minimizes cost of the rotor blade and of the turbine system by providing the lowest cost balance of weight, moment, and performance For example, the calculated benefit in moment of high performance materials applied to a 30 meters' span is ten times that at a 3 meters' span as measured from the root end 17. As a consequence, such materials become more cost effective when employed at the tip. Multiple materials can be employed along the span using mechanical or bonded joints, different material pultrusions or fiber mats within the spar or spar caps.

In certain aspects, a spar cap assembly for a jointed rotor blade 29 of a wind turbine includes a root spar cap assembly 60 and a tip spar cap assembly 80. The root spar cap assembly 60 includes a root tensile spar cap 62 and a root compressive spar cap 64, and is formed from a composite reinforced with fiberglass. The tip spar cap assembly 80 includes a tip tensile spar cap 82 and a tip compressive spar cap 84, and is formed from a composite reinforced with carbon fiber, aramid fiber, or a combination thereof. The thickness 102 of a joining end 54 of the root tensile spar cap 62 is at least 30% greater than the thickness 122 of a joining end 56 of the tip tensile spar cap 82. The thickness 104 of a joining end 54 of the root compressive spar cap 64 is at least 30% greater than the thickness 124 of a joining end 56 of the tip compressive spar cap 84.

In some embodiments, a method of forming a spar cap assembly is provided. The method includes forming a root spar cap assembly 60 that includes a root tensile spar cap 62 and a root compressive spar cap 64, from a first composite material, to engage a root spar 70 of a root blade segment 30. The method further includes forming a tip spar cap assembly 80 that includes a tip tensile spar cap 82 and a tip compressive spar cap 84, from a second composite material that is different from the first composite material, to engage a tip spar 90 of a tip blade segment 32. When formed, the thickness 102 of a joining end 54 of the root tensile spar cap 62 is different from the thickness 122 of a joining end 56 of the tip tensile spar cap 82, and the thickness 104 of the joining end 54 of the root compressive spar cap 64 is different from the thickness of the joining end 56 of the tip compressive spar cap 84. In some embodiments, the method further includes forming the root spar cap assembly 60 from a composite reinforced with fiberglass and forming the tip spar cap assembly from a composite reinforced with carbon fiber, aramid fiber, or a combination thereof. The root blade segment and the tip blade segments having the formed spar cap assemblies may be transported to the required assembly sites and joined in the assembly sites, thereby reducing the transportation cost.

In some aspects, a jointed rotor blade 29 (illustrated in FIG. 2) of a wind turbine is disclosed. The jointed rotor blade 29 includes a root blade segment 30 joined to a tip blade segment 32 at a joint 34 and a spar cap assembly (60 and 80 together) at the joint 34. The spar cap assembly includes a root spar cap assembly 60 and a tip spar cap assembly 80. The root spar cap assembly 60 includes a root tensile spar cap 62 and a root compressive spar cap 64, and is formed from a first composite material. The tip spar cap assembly 80 includes a tip tensile spar cap 82 and a tip compressive spar cap 84, and is formed from a second composite material that is different from the first composite material. The tip tensile spar cap 82 is adjacent to the root tensile spar cap 62 at the joint 34, and the tip compressive spar cap 84 is adjacent to the root compressive spar cap 64 at the joint 34. In certain embodiments, the tip tensile spar cap 82 is joined to the root tensile spar cap 62 at the joint 34, and the tip compressive spar cap 84 is joined to the root compressive spar cap 64 at the joint 34. The thickness 102 of a joining end 54 of the root tensile spar cap 62 is different from the thickness 122 of a joining end 56 of the tip tensile spar cap 82, and the thickness 104 of a joining end 54 of the root compressive spar cap 64 is different from the thickness 124 of a joining end 56 of the tip compressive spar cap 84.

In some embodiments, the thickness 102 of the joining end 54 of the root tensile spar cap 62 of the jointed rotor blade 29 is at least 30% greater than the thickness 122 of the joining end 56 of the tip tensile spar cap 82, and the thickness 104 of the joining end 54 of the root compressive spar cap 64 of the jointed rotor blade 29 is at least 30% greater than the thickness 124 of the joining end 56 of the tip compressive spar cap 84. In some embodiments, the root blade segment 30 and the tip blade segment 32 extend in opposite directions from a chord-wise joint 34 as illustrated in FIG. 2.

In some aspects, a wind turbine having a jointed rotor blade 29 (illustrated in FIG. 2) is disclosed. The jointed rotor blade 29 of the wind turbine 10 includes a root blade segment 30 joined to a tip blade segment 32 at a joint 34 and a spar cap assembly (60 and 80 together) at the joint 34. The spar cap assembly includes a root spar cap assembly 60 and a tip spar cap assembly 80. The root spar cap assembly 60 includes a root tensile spar cap 62 and a root compressive spar cap 64. Both the root tensile spar cap 62 and a root compressive spar cap 64 are formed from a first composite material. The tip spar cap assembly 80 includes a tip tensile spar cap 82 and a tip compressive spar cap 84. Both the tip tensile spar cap 82 and a tip compressive spar cap 84 are formed from a second composite material that is different from the first composite material. The tip tensile spar cap 82 is adjacent to the root tensile spar cap 62 at the joint 34, and the tip compressive spar cap 84 is adjacent to the root compressive spar cap 64 at the joint 34. In certain embodiments, the tip tensile spar cap 82 is joined to the root tensile spar cap 62 at the joint 34, and the tip compressive spar cap 84 is joined to the root compressive spar cap 64 at the joint 34. The thickness 102 of a joining end 54 of the root tensile spar cap 62 is different from the thickness 122 of a joining end 56 of the tip tensile spar cap 82, and the thickness 104 of a joining end 54 of the root compressive spar cap 64 is different from the thickness 124 of a joining end 56 of the tip compressive spar cap 84.

In some embodiments, the thickness 102 of the joining end 54 of the root tensile spar cap 62 of the jointed rotor blade 29 is at least 30% greater than the thickness 122 of the joining end 56 of the tip tensile spar cap 82, and the thickness 104 of the joining end 54 of the root compressive spar cap 64 of the jointed rotor blade 29 is at least 30% greater than the thickness 124 of the joining end 56 of the tip compressive spar cap 84. In some embodiments, the root blade segment 30 and the tip blade segment 32 extend in opposite directions from a chord-wise joint 34 as illustrated in FIG. 2.

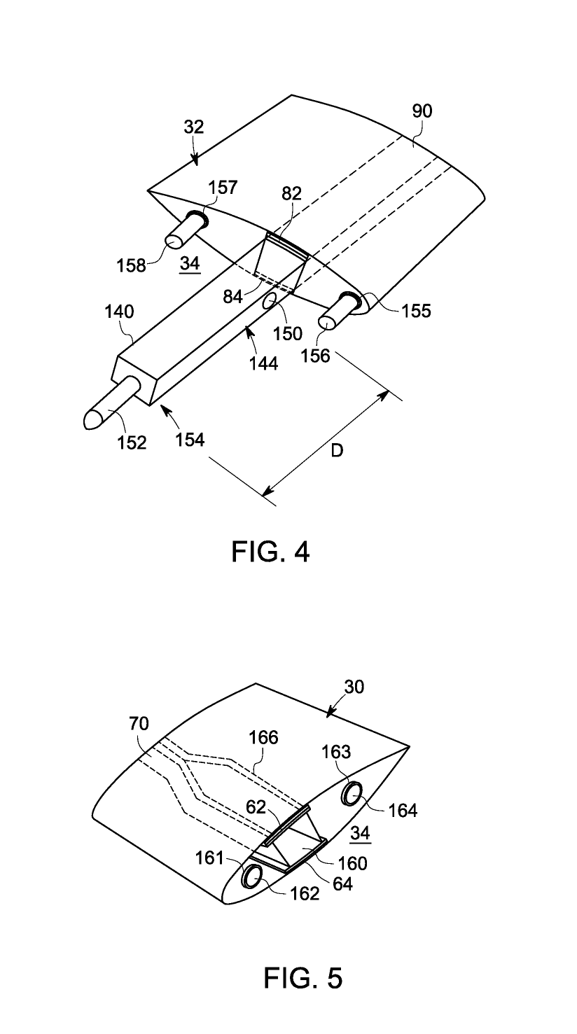

Different methods may be deployed to join the tip blade segment 32 to the root blade segment 30 at the joint 34 of the jointed rotor blade 29 including methods of physical joining, chemical joining, or mechanical joining. In some embodiments, the tip blade segment 32 is mechanically joined to the root blade segment 30. In some specific embodiments, the tip blade segment 32 has a spar structure that is joined to a specifically designed spar structure of the root blade segment 30 in a chord-wise joint. In some exemplary embodiments, the spar structure of the tip blade segment is joined to the spar structure of the root blade segment using bolt joints, as illustrated in FIGS. 4-6. The mechanical joining may include, without limitation, embedding, adhesive joining, capping, and attaching by using nut and bolts, or rivets.

FIG. 4 illustrates a perspective view of a section of the tip blade segment 32 in accordance with an example of the jointed rotor blade 29. The tip blade segment 32 includes a tip beam structure 140 that forms a portion of the tip spar 90 and extends lengthways for structurally connecting with the root blade segment 30. The beam structure 140 forms a part of the tip blade segment 32 having an extension protruding from a tip spar 90, thereby forming an extending spar section. The tip beam structure 140 includes a shear web 144 engaged by the tip tensile spar cap 82 and the tip compressive spar cap 84. Thus, in some embodiments, the tip spar cap assembly 80 (shown in FIG. 3B) engages the tip spar 90 of the tip blade segment 32.

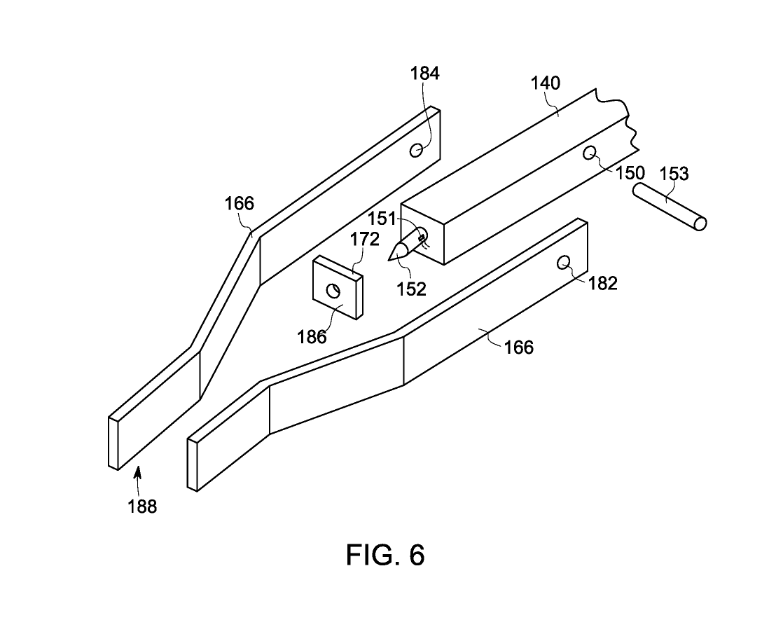

Further, the tip blade segment 32 includes one or more first bolt joint tubes located at a first end 154 of the tip beam structure 140. In a non-limiting example, the bolt joint tube includes a pin that is in a tight interference fit with a bush. As shown, the one or more bolt joint tubes includes one bolt joint tube 152 located on the beam structure 140. As shown, the bolt joint tube 152 is oriented in a span-wise direction. The tip blade segment 32 also includes one bolt joint slot 150 located on the beam structure 140 proximate to the chord-wise joint 34. This bolt joint slot 150 is oriented in a chord-wise direction. In one example, there may be a bushing within the bolt joint slot 150 arranged in a tight interference fit with a bolt tube or pin (shown as pin 153 in FIG. 6). Further, the tip blade segment 32 includes a plurality of second bolt joint tubes 156, 158 located at the chord-wise joint 34. The plurality of second bolt joint tubes 156, 158 include a leading edge bolt joint tube 156 and a trailing edge bolt joint tube 158. Each of the leading edge bolt joint tube 156 and the trailing edge bolt joint tube 158 is oriented in a span-wise direction. In one example, each of the plurality of second bolt joint tubes 156, 158 include multiple flanges 155, 157 respectively that are configured to distribute compression loads at the chord-wise joint 34.

In certain embodiments, the jointed rotor blade 29 includes one or more first bolt joint tubes 152 located at the first end 154 of the tip beam structure 140 for connecting with the receiving section of the root blade segment 30, and a plurality of second bolt joint tubes 156, 158 located at the chord-wise joint 34, wherein the first bolt joint tubes 152 located at the first end 154 of the tip beam structure 140 are separated span-wise with the plurality of second bolt joint tubes 156, 158 located at the chord-wise joint 34. It is to be noted that the first joint bolt tube 152 located at the first end of beam structure 140 is separated span-wise with the plurality of second bolt joint tubes 156, 158 located at the chord-wise joint 34 by an optimal distance D. This optimal distance D may be such that the chord-wise joint 34 is able to withstand substantial bending moments caused due to shear loads acting on the chord-wise joint 34. In one non-limiting example, each of the bolt joints connecting the root blade segment 30 and the tip blade segment 32 may include an interference-fit steel bushed joint.

FIG. 5 is a perspective view of a section of the root blade segment 30 at the chord-wise joint 34 in accordance with an example of the present disclosure. The root blade segment 30 shows a receiving section 160 extending lengthways within the root blade segment 30 for receiving the beam structure 140 of the tip blade segment 32 (illustrated in FIG. 4). In certain embodiments, the tip spar 90 of the tip blade segment 32 comprises a tip beam structure 140 extending lengthways and structurally connecting with the root blade segment 30 at a receiving section 160 of the spar of the root blade segment 30. The receiving section 160 includes multiple root spar structures 166 as a part of the root spar 70, that extend lengthways for connecting with the tip beam structure 140 of the tip blade segment 32. As shown, the root blade segment 30 further includes bolt joint slots 162, 164 for receiving bolt joint tubes 156, 158 (shown in FIG. 4) of the tip blade segment 32 and forming tight interference fittings. Thus, in certain embodiments, the receiving section 160 of the root blade segment 30 includes the plurality of root spar structures 166 extending lengthways and connecting with the tip beam structure 140 of the tip blade segment 32 through the second bolt joint tubes in the chord-wise direction.

In one example, each of the multiple bolt joint slots 162, 164 include multiple flanges 161, 163 respectively that are configured to distribute compression loads at the chord-wise joint 34. The multiple root spar structures are engaged by the root tensile spar cap 62 and the root compressive spar cap 64. Thus, in some embodiments, the root spar cap assembly 60 engages a root spar 70 of the root blade segment 30. In certain embodiments, the tip spar cap assembly 80 engages a tip spar 90 of the tip blade segment 32 and the root spar cap assembly 60 engages a root spar 70 of the root blade segment 30.

FIG. 6 shows a perspective view of the exemplary jointed rotor blade 29 at the joint 34, wherein the tip spar 90 of the tip blade segment 32 includes a tip beam structure 140 extending lengthways and structurally connecting with the root blade segment 30 at a receiving section of the root spar 70 of the root blade segment 30. As shown, a pair of root spar structures 166 is configured to receive the beam structure 140 and includes bolt joint slots 182, 184 that are aligned with the bolt joint slot 150 of the beam structure 140 through which a bolt tube or pin 153 is inserted and remains in a tight interference fit such that root spar structures 166 and the beam structure 140 are joined together by during assembling. FIG. 6 also shows the rectangular fastening element 172 that includes a bolt joint slot 186 configured for receiving the bolt tube 152 of the beam structure 140 forming a tight interference fit bolted joint. Further, the pair of root spar structures 166 is joined together at one end 188 using a suitable adhesive material or an elastomeric seal. In one example, a sensor element 151 is disposed in the pin or bolt tube 152. The sensor element may help in receiving and sending signals to a control unit (not shown) of the wind turbine, which signals may enable sensing multiple parameters including blade loads or stresses. This may help in effective operation of the wind turbine.

Advantageously, the present disclosure ensures efficient reduction of connecting loads, leading to simplified moment flow between the multiple supporting structures of the wind blade. Further, the present disclosure ensures low cost, reliable, and scalable connections. Due to the customizable blade geometry and segmented blade parts, there is reduction in transportation costs. Furthermore, the easy handling and assembling of the wind blade leads to reduction of turbine down time during wind blade maintenance.

Furthermore, the skilled artisan will recognize the interchangeability of various features from different embodiments. Similarly, the various features described, as well as other known equivalents for each such feature, can be mixed and matched by one of ordinary skill in this art to construct additional systems and techniques in accordance with principles of this disclosure, and are presumed to be covered herein. Further, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A spar cap assembly for a jointed rotor blade of a wind turbine, the spar cap assembly comprising:
a root spar cap assembly comprising a root tensile spar cap and a root compressive spar cap; and
a tip spar cap assembly comprising a tip tensile spar cap and a tip compressive spar cap,
wherein the root spar cap assembly is formed from a first composite material, and the tip spar cap assembly is formed from a second composite material that is different from the first composite material, and
wherein a thickness of a joining end of the root tensile spar cap is different from a thickness of a joining end of the tip tensile spar cap, and a thickness of a joining end of the root compressive spar cap is different from a thickness of a joining end of the tip compressive spar cap.

2. The spar cap assembly of claim 1, wherein the first composite material is reinforced with fiberglass.

3. The spar cap assembly of claim 1, wherein the second composite material is reinforced with carbon fiber, aramid fiber, or a combination thereof.

4. The spar cap assembly of claim 1, wherein the first composite material is reinforced with fiberglass, and the second composite material is reinforced with carbon fiber, aramid fiber, or a combination thereof.

5. The spar cap assembly of claim 1, wherein the thickness of the joining end of the root tensile spar cap is greater than the thickness of the joining end of the tip tensile spar cap, and the thickness of the joining end of the root compressive spar cap is greater than the thickness of the joining end of the tip compressive spar cap.

6. The spar cap assembly of claim 5, wherein the thickness of the joining end of the root tensile spar cap is at least 30% greater than the thickness of the joining end of the tip tensile spar cap.

7. The spar cap assembly of claim 5, wherein the thickness of the joining end of the root compressive spar cap is at least 30% greater than the thickness of the joining end of the tip compressive spar cap.

8. The spar cap assembly of claim 5, wherein a specific strength of the second composite material is at least 30% greater than the specific strength of the first composite material.

9. The spar cap assembly of claim 5, wherein elastic modulus of the second composite material is at least 30% greater than elastic modulus of the first composite material.

10. The spar cap assembly of claim 1, wherein a width of the joining end of the root tensile spar cap is greater than a width of the joining end of the tip tensile spar cap, and a width of the joining end of the root compressive spar cap is greater than a width of the joining end of the tip compressive spar cap.

11. A jointed rotor blade of a wind turbine, comprising:
a root blade segment joined to a tip blade segment at a joint; and
a spar cap assembly at the joint, comprising:
a root spar cap assembly comprising a root tensile spar cap and a root compressive spar cap; and
a tip spar cap assembly comprising a tip tensile spar cap and a tip compressive spar cap,
wherein the root spar cap assembly is formed from a first composite material, and the tip spar cap assembly is formed from a second composite material that is different from the first composite material,
wherein the tip tensile spar cap is adjacent to the root tensile spar cap at the joint, and the tip compressive spar cap is adjacent to the root compressive spar cap at the joint, and
wherein a thickness of a joining end of the root tensile spar cap is different from a thickness of a joining end of the tip tensile spar cap, and a thickness of a joining end of the root compressive spar cap is different from a thickness of a joining end of the tip compressive spar cap.

12. The jointed rotor blade of claim 11, wherein the thickness of the joining end of the root tensile spar cap is at least 30% greater than the thickness of the joining end of the tip tensile spar cap, and the thickness of the joining end of the root compressive spar cap is at least 30% greater than the thickness of the joining end of the tip compressive spar cap.

13. The jointed rotor blade of claim 12, wherein the root blade segment and the tip blade segment extend in opposite directions from a chord-wise joint.

14. The jointed rotor blade of claim 12, wherein the tip spar cap assembly engages a spar of the tip blade segment, and the root spar cap assembly engages a spar of the root blade segment.

15. The jointed rotor blade of claim 14, wherein the spar of the tip blade segment comprises a tip beam structure extending lengthways and structurally connecting with the root blade segment at a receiving section of the spar of the root blade segment.

16. The jointed rotor blade of claim 15, further comprising one or more first bolt joint tubes located at a first end of the tip beam structure for connecting with the receiving section of the root blade segment, and a plurality of second bolt joint tubes located at the chord-wise joint, wherein the first bolt joint tubes located at the first end of the tip beam structure are separated span-wise with the plurality of second bolt joint tubes located at the chord-wise joint.

17. The jointed rotor blade of claim 16, wherein the plurality of second bolt joint tubes comprises a leading edge bolt joint tube and a trailing edge bolt joint tube.

18. The jointed rotor blade of claim 16, wherein the first bolt joint tube located at the first end of the tip beam structure is oriented in a span-wise direction and a second bolt joint tube of the plurality of second bolt joint tubes located at the chord-wise joint on the tip beam structure is oriented in a chord-wise direction.

19. The jointed rotor blade of claim 16, wherein the receiving section of the root blade segment comprises a plurality of root spar structures extending lengthways and connecting with the tip beam structure of the tip blade segment through the second bolt joint tubes in the chord-wise direction.

20. A wind turbine comprising a jointed rotor blade, the jointed rotor blade comprising:
a root blade segment joined to a tip blade segment at a joint; and
a spar cap assembly at the joint, comprising:
a root spar cap assembly comprising a root tensile spar cap and a root compressive spar cap; and
a tip spar cap assembly comprising a tip tensile spar cap and a tip compressive spar cap,
wherein the root spar cap assembly is formed from a first composite material, and the tip spar cap assembly is formed from a second composite material that is different from the first composite material,
wherein the tip tensile spar cap is adjacent to the root tensile spar cap at the joint, and the tip compressive spar cap is adjacent to the root compressive spar cap at the joint, and
wherein a thickness of a joining end of the root tensile spar cap is different from a thickness of a joining end of the tip tensile spar cap, and a thickness of a joining end of the root compressive spar cap is different from a thickness of a joining end of the tip compressive spar cap.
